(19) United States
(12) Patent Application Publication
(10) Pub. No.: US 2013/0257031 A1
(43) Pub. Date: Oct. 3, 2013

(54) Interlocking Foam Book

(71) Applicant: Jim Lai, Santa Monica, CA (US)

(72) Inventor: Jim Lai, Santa Monica, CA (US)

(21) Appl. No.: 13/436,178

(22) Filed: Mar. 30, 2012

(51) Int. Cl. B42D 1/00

(52) U.S. Cl. 281/15.1

(57) ABSTRACT

Present invention relates to a foam book design for children of early ages, where cutout manipulative pieces from the foam pages allow for playing in a puzzle-like fashion; the foam pages are collected together in an interlocking manner and can be looped around the rings or disk-shaped objects along the cutout side holes on each foam page.

### FIELD OF THE INVENTION

The present invention relates to foam book design for children of early ages, where cutout manipulative pieces from the foam pages allow for playing in a puzzle-like fashion. The foam pages are collected together in an interlocking manner and can be looped around the rings or disk-shaped objects along the cutout side holes on each foam page.

### BACKGROUND OF THE INVENTION

Different types of children foam books are available on the market and there are a number of patents in this regard.

Notably, Derraugh U.S. Pat. No. 6,390,507 patent, Kaufman U.S. Pat. No. 6,189,932 patent, and Kaufman U.S. Pat. No. 6,336,665 patent all provided the disclosure of foam books for young children. However, these prior art patents did not allow any particular foam page(s) to be independently selected and taken out for play, due to the binding means used.

The prior art patent of Legrand U.S. Pat. No. 7,258,367 taught the construction of a “loosely bound” foam book, where a binding strap closure strap (4) is used to string through the binder slots(2) of the foam pages. Though such “strap through slot” structure allows for the foam pages to be taken out, it lacks the ease and the convenience of the interlocking means disclosed in present invention.

Present invention specifically teaches the structure to allow individual elements of the foam book to be taken out for individual play purpose, due to the interlocking means adopted herein.

### OBJECTS AND SUMMARY OF THE INVENTION

An object of present invention is to provide a children's foam book where the individual pages can be taken out for independent play and then easily put back into the same or a different position, due to the interlocking mechanism used.

There is no distinction between a “front” page or a “back” page, as there is no “binding” means used, as disclosed and discussed by known prior art patents or products.

Another object of present invention is to provide a manipulative cutout piece from a foam page, where a hole or a recess of corresponding shape is made, so that said cutout piece can be fitted back into the foam page, in a puzzle-fitting fashion.

Yet another object of present invention is to allow the materials used, both the foam pages and the interlocking disk-oriented objects or rings, to be washable and also safe of children's inadvertent chewing, thus enhancing the sanity safety for the play-to-learn activities of children using presenting invention.

### BRIEF DESCRIPTION OF THE DRAWINGS

FIG. 1 illustrates a first embodiment of the invention.

FIG. 2A shows the foam pages being collected, with a manipulative piece “afloat” over the first foam page shown.

FIG. 2B shows all the separate parts in a ring interlocking implementation.

FIG. 3A-3C show the three sides of the view when a foam book is “closed”.

FIG. 4A shows cutout profile view of a disk-oriented object.

FIG. 4B shows the cutout perspective view of a disk-oriented object.

### DETAILED DESCRIPTION OF THE PREFERRED EMBODIMENT

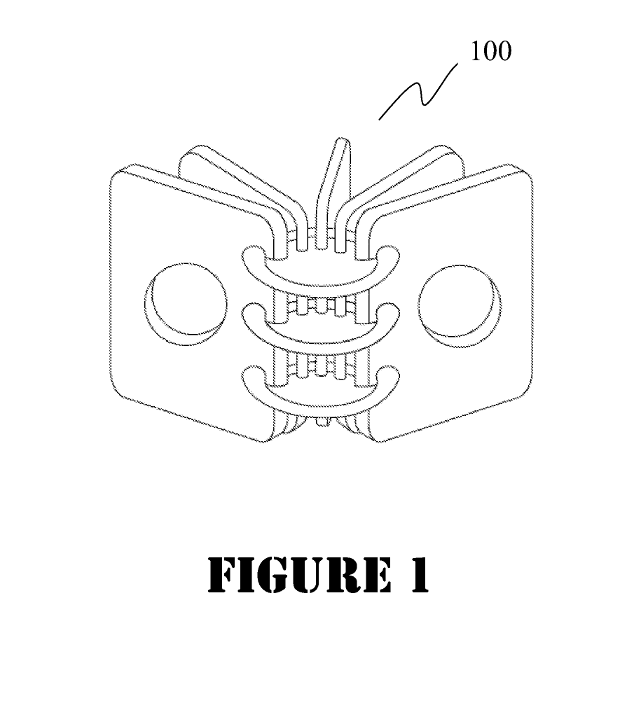

FIG. 1 shows an assembled view of a foam book 100 of present invention.

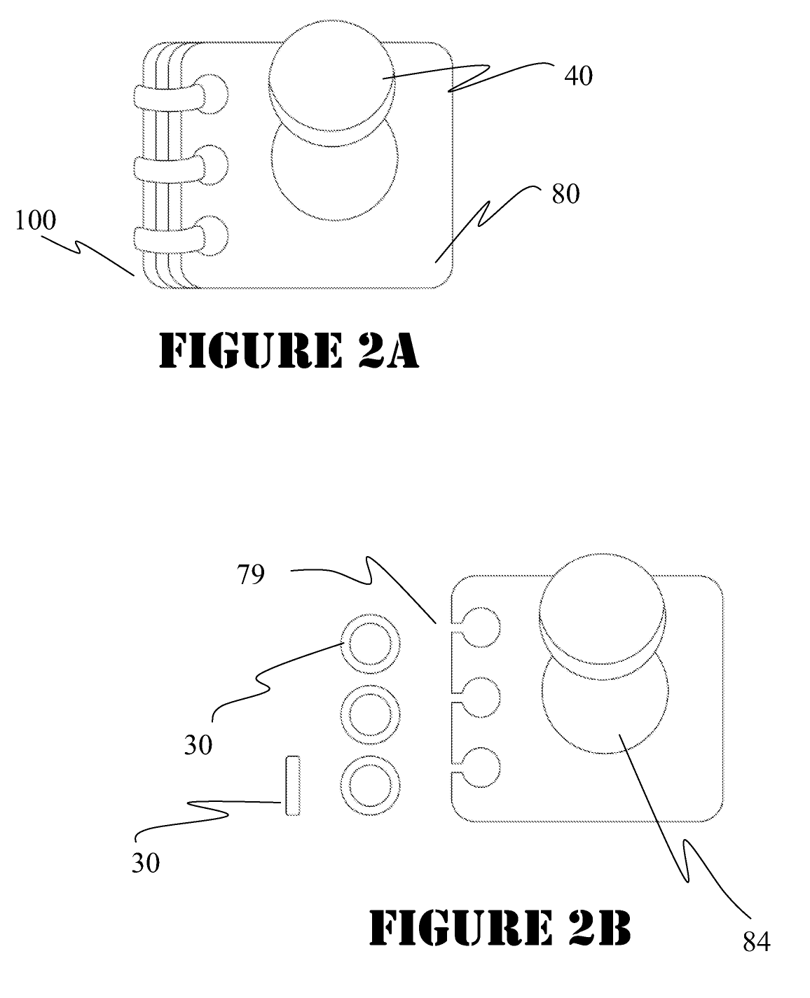

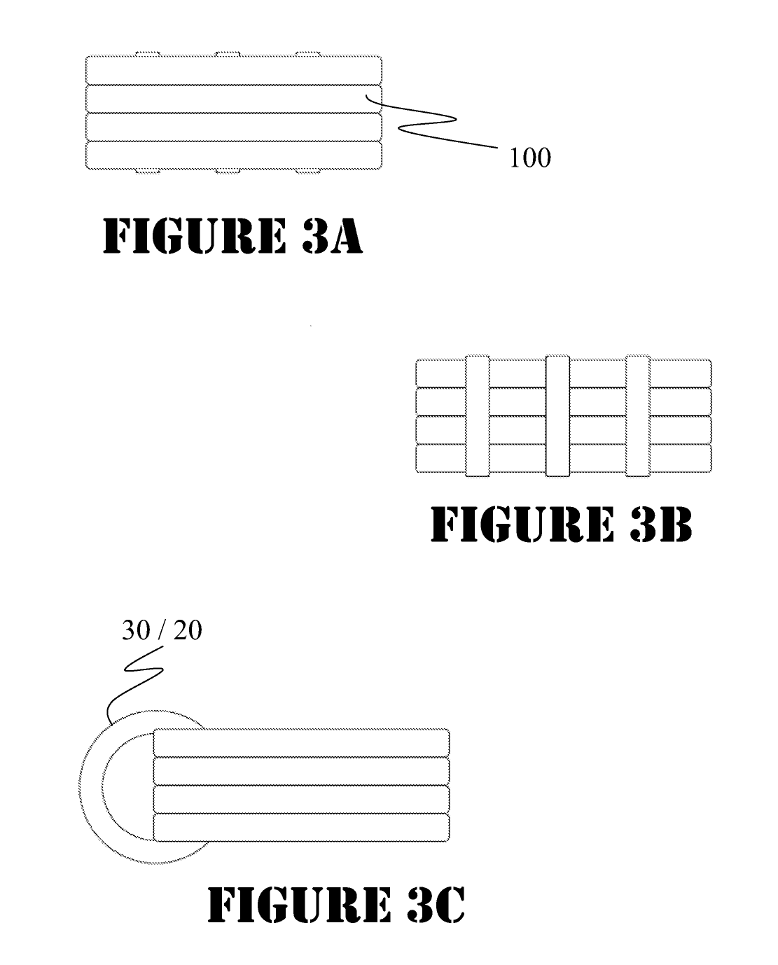

As shown in FIG. 2B, a foam page 80 has a plurality of cut-out side holes 79 on the edge to one side of said foam page 80.

Said side holes 79 are sized to fit the sliding engagement of a plurality of disk-shaped objects 20 or rings 30.

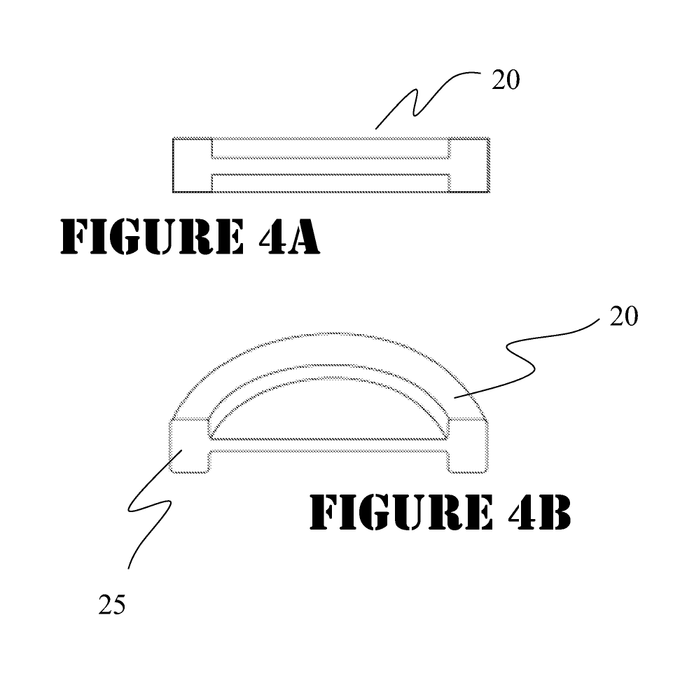

For said plurality of disk-shaped objects 20, the edge of which will be made to be ribbed, to provide the engaging fitting to said cut-out side holes 79. See FIG. 4A and 4B for implementation of present invention by the use of disk-shaped object 20.

A ring of ribbed peripheral edge 25 is formed along the outside periphery of said disk-shaped object 20. Said ribbed edge 25 is sized to fit the cut-out side holes 79, so as to form an easy interlocking means between said disk-shaped objects 20 and the foam pages 80, and allowing for individual disassociation of any selected foam page 80 to be taken out for independent play.

In the mid portion of each foam page 80, a cut-out manipulative piece 40 may be made, resulting in a corresponding cut-out hole 84 on said foam page 80. The manipulative piece 40 can be fitted into said cut-out hole 84, like a puzzle piece fitting fashion.

Foam pages 80 are not bound together, by any binding means. The foam book 100 of present invention thus contains all the foam pages 80 in an interlocking fashion and these foam pages 80 can freely loop around the rings 30 or the disk-shaped objects 20.

Moreover, the design of no-binding means to present invention allows any of the foam pages 80 to be easily taken out from the rings 30 or the disk-shaped objects 20.

Also, the foam pages 80 of present invention loop around the rings 30 or disk-shaped objects 20 with no distinction of any front or back cover page.

The materials used for the foam pages 80, the cutout manipulative pieces 40, the rings 30 and the disk-shaped objects 20 are all washable and are safe for children's inadvertent chewing.

The invention claimed is:

1. An interlocking foam book, comprising:
a plurality of foam pages;
a plurality of flexible disk-shaped objects with ribbed peripheral edge; and,
a plurality of cut-out side holes made on one side of said foam page whereby said disk-shaped objects can be slidingly engaged into said side holes, resulting in said foam pages looping around the ribbed peripheral edge of said disk-shaped objects.

2. The foam book of claim 1, wherein said foam pages may contain a removable manipulative piece which corresponds to a cut-out hole on said foam pages in a puzzle-like fashion.

3. The foam book of claim 1, wherein said foam pages and disk-shaped objects are washable.

4. The foam book of claim 1, wherein said foam pages and disk-shaped objects are safe for children's inadvertent chewing.

5. An interlocking foam book, comprising:
a plurality of foam pages;
a plurality of rings; and, a plurality of cut-out side holes made on one side of said foam page whereby said rings can be slidingly engaged into said side holes, resulting in said foam pages looping around the rings.

6. The foam book of claim 1, wherein said foam pages may contain a removable manipulative piece which corresponds to a cut-out hole on said foam pages in a puzzle-like fashion.

7. The foam book of claim 1, wherein said foam pages and rings are washable.

8. The foam book of claim 1, wherein said foam pages and rings are safe for children's inadvertent chewing.
